(19) United States
(12) Patent Application Publication
(10) Pub. No.: US 2016/0214862 A1
(43) Pub. Date: Jul. 28, 2016

(54) PROCESSES FOR SYNTHESIZING MAGNESIUM SELENIDE NANOCRYSTALS

(71) Applicant: SAMSUNG ELECTRONICS CO., LTD., Suwon-si, Gyeonggi-do (KR)

(72) Inventors: Taekhoon KIM, Hwaseong-si, Gyeonggi-do (KR); Eun Joo JANG, Suwon-si, Gyeonggi-do (KR); Hyo Sook JANG, Suwon-si, Gyeonggi-do (KR); Shin Ae JUN, Seongnam-si, Gyeonggi-do (KR); Hyunki KIM, Suwon-si, Gyeonggi-do (KR)

(21) Appl. No.: 14/908,710

(22) PCT Filed: Jul. 24, 2014
(86) PCT No.: PCT/KR2014/006761

§ 371 Date: Jan. 29, 2016

(30) Foreign Application Priority Data
Aug. 1, 2013 (KR) 10-2013-0091576

(51) Int. Cl. C01B 19/00; H01B 1/02

(52) U.S. Cl. CPC C01B 19/007; H01B 1/02

(57) ABSTRACT

A process of synthesizing Mg—Se nanocrystals is provided, the process including reacting a first precursor including magnesium and a second precursor including selenium in the presence of a ligand compound in an organic solvent to form a nanocrystal of MgSe or an alloy thereof, wherein the organic solvent and the ligand compound do not include an oxygen functional group.

### TECHNICAL FIELD

This application claims priority to and the benefit of Korean Patent Application No. 10-2013-0091576 filed on Aug. 1, 2013, the content of which is incorporated herein in its entirety by reference.

A process for synthesizing magnesium selenide nanocrystals is disclosed.

### BACKGROUND ART

Unlike bulk materials, nanoparticles may adjust their physical characteristics (e.g., energy bandgap and melting point) by changing their size. For example, a semiconductor nanocrystal (also known as a quantum dot) is a semiconductor material having a crystalline structure of a size of several nanometers. When the semiconductor nanocrystal becomes smaller than its Bohr radius, it may exhibit a quantum confinement effect, which cannot be observed in its bulk state, and in terms of its optical properties, the semiconductor nanocrystal may have an increased bandgap and a high level of energy density as its size further decreases. The quantum dot has some advantages in that its light emitting wavelength may be controlled more easily than any conventional phosphor material and its color purity is very high. Accordingly, various efforts have been exerted to search for the utility of the quantum dot as a light emitting material for a backlight unit in LEDs or display devices, and it may also be utilized as a bio-tag material. However, only a few researches have been made on a Cd free, Group II-VI semiconductor nanocrystal. Because most of the Group II-VI semiconductor nanocrystals being commonly used include cadmium, it is very desirable to develop a nanocrystal that does not include cadmium as its main component.

A semiconductor nanocrystal (i.e., a quantum dot) may be synthesized by a vapor deposition method such as metal organic chemical vapor deposition (MOCVD) and molecular beam epitaxy (MBE), or by a wet chemical method of adding a precursor to an organic solvent to grow crystals. In the wet chemical method, an organic material such as a dispersant is coordinated to a surface of the semiconductor crystal during the crystal growth to control the crystal growth. Therefore, the nanocrystals produced by the wet chemical method usually have a more uniform size to and shape than those produced by the vapor deposition method.

A semiconductor nanocrystal including MgSe or an alloy thereof (hereinafter, a Mg—Se semiconductor nanocrystal) may exclude cadmium as its main component. Although the Mg—Se semiconductor nanocrystal has been synthesized via the vapor deposition method, no reports have been made as to synthesizing it via the wet chemical method. Thus, an urgent need to develop technologies for preparing the Mg—Se nanocrystal via the wet chemical method still remains.

### DISCLOSURE

### Technical Problem

An embodiment is directed to a process for preparing various Mg—Se semiconductor nanocrystals via a wet chemical method.

Another embodiment is directed to nanoparticles including the Mg—Se semiconductor nanocrystal.

### Technical Solution

According to an embodiment, a process of synthesizing Mg—Se nanocrystals is provided, the process including:

reacting a first precursor containing magnesium and a second precursor containing selenium in the presence of a ligand compound in an organic solvent to form nanocrystals of MgSe or an alloy thereof, wherein the organic solvent and the ligand compound do not include an oxygen functional group.

The first precursor may be an alkylated magnesium compound, a complex of magnesium metal and a phosphine compound, a complex of magnesium metal and a to thiol compound, a magnesium halide, magnesium cyanide, a magnesium amide, a cycloalkenyl magnesium compound, a cycloalkyl magnesium compound, an allyl magnesium compound, bis(cyclopentadienyl)-magnesium, magnesium phthalocyanine, or a combination thereof.

The second precursor may be a complex consisting of selenium and a compound selected from a dialkyl phosphine, a diaryl phosphine, a trialkyl phosphine, a friaryl phosphine, and a combination thereof, bis(trialkylsilyl)selenide, diphenyl selenide, an alkyl selenide, a cycloalkenyl selenide, a cycloalkyl selenide, or a combination thereof.

The organic solvent may be a C6 to C22 primary alkyl amine, a C6 to C22 secondary alkyl amine, C6 to C40 tertiary alkyl amine, a heterocyclic compound having a nitrogen atom, a C6 to C40 olefin, a C6 to C40 aliphatic hydrocarbon, an aromatic hydrocarbon substituted with a C6 to C30 alkyl group, a phosphine substituted with a C6 to C22 alkyl group, or a combination thereof.

The ligand compound may be at least one selected from the group consisting of RNH2, R2NH, R3N, RSH, and R3P, wherein R is independently a C1 to C24 alkyl group, a C2 to C24 alkenyl group, or a C5 to C20 aryl group.

The reacting the first precursor and the second precursor may include reacting the first and second precursors together with a third precursor that contains an element (A) of a metal or a non-metal other than Mg and Se.

The element (A) of a metal or a non-metal may be at least one selected from Zn, Ga, In, S, and Te.

The reacting the first precursor and the second precursor may include reacting to the first and second precursors in the presence of a first nanocrystal to form a nanocrystal shell of MgSe or an alloy thereof on the surface of the first nanocrystal.

The first nanocrystal may be a Group III-V semiconductor nanocrystal core or a core-shell type semiconductor nanocrystal having a Group III-V semiconductor nanocrystal on the shell thereof.

Another embodiment provides a nanoparticle including a nanocrystal of a compound represented by Chemical Formula 1:

MgaAbSe [Chemical Formula 1]

wherein a is an atomic ratio of Mg with respect to Se, a+b=1, 0<a≦1, b is an atomic ratio of an element A, 0≦b<1, and the element A is a Group II metal other than magnesium, a Group III metal, a Group V non-metal element, a Group VI non-metal element other than selenium, or a combination thereof.

The compound represented by Chemical Formula 1 may be MgSe.

The nanoparticle may have a multi-shell structure, and the nanocrystal of the compound represented by Chemical Formula 1 may be present as an interlayer between a Group III-V semiconductor nanocrystal and a Group II-VI semiconductor nanocrystal.

The Group III-V semiconductor nanocrystal may be selected from the group consisting of:
a binary element compound selected from GaN, GaP, GaAs, GaSb, AIN, AIP, AIAs, AISb, InN, InP, InAs, InSb, and a combination thereof;

a ternary element compound selected from GaNP, GaNAs, GaNSb, GaPAs, GaPSb, AINP, AINAs, AINSb, AIPAs, AIPSb, InNP, InNAs, InNSb, InPAs, InPSb, GaAINP, and a combination thereof; and a quaternary element compound selected from GaAINAs, GaAINSb, GaAIPAs, GaAIPSb, GaInNP, GaInNAs, GaInNSb, GaInPAs, GaInPSb, InAINP, InAINAs, InAINSb, InAIPAs, InAIPSb, and a combination thereof.

The Group III-V semiconductor nanocrystal may be a Group III-V semiconductor nanocrystal doped with a Group II element.

The Group II-VI compound may be selected from:

a binary element compound selected from CdSe, CdTe, ZnS, ZnSe, ZnTe, ZnO, HgS, HgSe, HgTe, MgSe, MgS, and a combination thereof;

a ternary element compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a combination thereof; and a quaternary element compound selected from HgZnTeS, CdZnSeS, CdZnSeTe, CdZnSTe, CdHgSeS, CdHgSeTe, CdHgSTe, HgZnSeS, HgZnSeTe, HgZnSTe, and a combination thereof.

The nanocrystal of the compound represented by Chemical Formula 1 may include at least one ligand compound coordinated on a surface thereof, the ligand compound being selected from the group consisting of RNH2, R2NH, R3N, RSH, and R3P, wherein R is independently a C1 to C24 alkyl group, a C2 to C24 alkenyl group, or a C5 to C20 aryl group.

### Advantageous Effects

In accordance with the aforementioned methods of synthesizing a nanocrystal, a nanoparticle including a Mg—Se nanocrystal having various compositions may be prepared via the wet chemical method. The Mg—Se to nanocrystal is a semiconductor material having a wide bandgap, and the method makes it possible to design a novel light-emitting particle having a quantum well structure with a Mg—Se nanoparticle core. For example, the Mg—Se nanocrystal may be applied as an interlayer shell on the Group III-V semiconductor nanocrystal core, potentially enabling an excellent passivation effect using its wide bandgap.

### DESCRIPTION OF DRAWINGS

These and/or other aspects will become apparent and more readily appreciated from the following description of the embodiments, taken in conjunction with the accompanying drawings, in which:

FIG. 1 is an X-ray diffraction spectrum of the Mg—Se nanocrystal synthesized in Example 1;

FIG. 2 is an X-ray diffraction spectrum of the Mg—Se nanocrystal synthesized in Example 2;

FIG. 3 is an X-ray diffraction spectrum of the nanocrystal synthesized in a comparative example;

FIG. 4 is a UV spectrum of the nanocrystals each synthesized in Example 1, Example 2, and the comparative example; and

FIG. 5 is an X-ray diffraction spectrum of the Mg—Se nanocrystal synthesized in Example 3;

FIG. 6 is an X-ray diffraction spectrum of the Mg—Se nanocrystal synthesized in Example 4; and

FIG. 7 is an X-ray diffraction spectrum of the Mg—Se nanocrystal synthesized in Example 5.

### BEST MODE

This disclosure will be described more fully hereinafter in the following detailed description, in which some but not all embodiments of this disclosure are described. This disclosure may be embodied in many different forms and is not be construed as limited to the embodiments set forth herein; rather, these embodiments are provided so that this disclosure will fully convey the scope of the invention to those skilled in the art. Thus, in some exemplary embodiments, well known technologies are not specifically explained to avoid ambiguous understanding of the present invention. Unless otherwise defined, all terms used in the specification (including technical and scientific terms) may be used with meanings commonly understood by a person having ordinary knowledge in the art. Further, unless explicitly defined to the contrary, the terms defined in a generally-used dictionary are not ideally or excessively interpreted. In addition, unless explicitly described to the contrary, the word “comprise” and variations such as “comprises” or “comprising” will be understood to imply the inclusion of stated elements but not the exclusion of any other elements.

Unless specifically described to the contrary, a singular form includes a plural form.

As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly to on” another element, there are no intervening elements present.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise. Unless specified otherwise, the term “or” means “and/or.”

As used herein, the term “Mg—Se nanocrystal” refers to a nanocrystal of MgSe or an alloy thereof (including magnesium and selenium).

As used herein, the term “oxygen functional group” refers to a group that includes an oxygen element and may react with the first precursor, such as a carboxylic acid group, a carbonyl group, or a hydroxyl group.

A process of synthesizing a Mg—Se nanocrystals according to an embodiment includes reacting a first precursor including magnesium and a second precursor including selenium in the presence of a ligand compound in an organic solvent, and optionally together with a third precursor, to form a nanocrystal of MgSe or an alloy thereof, wherein the organic solvent and the ligand compound does not include an oxygen functional group.

So far, synthesizing the nanocrystal of MgSe or an alloy thereof has been limited to a gas-phase vapor deposition method (e.g., MBE) since magnesium has a strong oxophilic characteristic. Due to such oxophilic characteristic, in the synthesis of the Mg—Se nanocrystal via the wet chemical method, the oxygen containing compound such as a ligand compound (e.g., a carboxylic acid, an alkyl alcohol, and the like) may act as an oxygen source in a reaction system even when it is present in a very small amount, leading to the formation of a very stable bond between Mg and O, and thereby making the formation of the Mg—Se bond far more difficult. By contrast, according to the nanocrystal synthesis method of the aforementioned embodiment, the first precursor including Mg and the second precursor including Se may react in the presence of a ligand compound without an oxygen functional group and a solvent without an oxygen functional group, and thereby it becomes possible to stably form a Mg—Se bond. Accordingly, the Mg—Se nanoparticle may be synthesized via the wet chemical route.

In a non-limiting example, the method may be carried out in the following manner. The ligand compound and the solvent are placed in a reactor and heated under vacuum so as to remove the oxygen source, for example, substantially completely. Then, in an inert atmosphere, the Mg-containing first precursor and the Se-containing second precursor are injected into the reactor simultaneously, or step by step, or as a mixture. The temperature of the reactor is then raised to a reaction temperature to carry out a reaction between the precursors and thereby a Mg—Se nanocrystal is obtained. The reaction conditions such as reaction temperature, reaction time, and pressure are not particularly limited, but they may be chosen appropriately.

In this method, the first precursor containing Mg may be an alkylated to magnesium compound, a complex of a magnesium metal and a phosphine compound, a complex of a magnesium metal and a thiol compound, a magnesium halide, magnesium cyanide, a magnesium amide, a cycloalkenyl magnesium compound, a cycloalkyl magnesium compound, an allyl magnesium compound, bis(cyclopentadienyl)-magnesium, magnesium phthalocyanine, or a combination thereof. Examples of the first precursor may include, but are not limited to, dibutyl magnesium, dimethyl magnesium, and a combination thereof.

The second precursor containing Se may be a complex of selenium with a compound selected from a dialkyl phosphine, a diaryl phosphine, a trialkyl phosphine, a friaryl phosphine, and a combination thereof, bis(trialkylsilyl)selenide, diphenyl selenide, an alkyl selenide, a cycloalkenyl selenide, a cycloalkyl selenide, or a combination thereof. Examples of the second precursor may include, but are not limited to, a Se/trioctyl phosphine complex, a Se/diphenylphosphine (DPP) complex, bis(trimethylsilyl)selenide, and a combination thereof.

The organic solvent may be a C6 to C22 primary alkyl amine such as hexadecylamine, dodecylamine, a C6 to C22 secondary alkyl amine such as dioctylamine, C6 to C40 tertiary alkyl amine such as trioctylamine, a heterocyclic compound having a nitrogen atom such as pyridine, a C6 to C40 olefin such as tetradecene, octadecene, hexadecene, and squalene, a C6 to C40 aliphatic hydrocarbon such as hexadecane and octadecane, an aromatic hydrocarbon substituted with a C6 to C30 alkyl group such as phenyldodecane, phenyltetradecane, and phenyl hexadecane, a phosphine substituted with a C6 to C22 alkyl group such as trioctylphosphine, or a combination thereof.

The ligand compound may be at least one selected from the group consisting of RNH₂, R₂NH, R₃N, RSH, and R₃P, wherein R is independently a C1 to C24 alkyl to group, a C2 to C24 alkenyl group, or a C5 to C20 aryl group. The ligand compound is coordinated to the surface of the nanocrystals as prepared, plays a role of well-dispersing the nanocrystals in a solution, and may have an effect on the light-emitting and electrical characteristics of the nanocrystals. The ligand compound may be used alone or in a mixture of at least two compounds. Examples of the organic ligand compound may include, but are not limited to, methanethiol, ethanethiol, propanethiol, butanethiol, pentanethiol, hexanethiol, octanethiol, dodecanethiol, hexadecanethiol, octadecanethiol, benzylthiol, methylamine, ethylamine, propylamine, butylamine, pentaneamine, hexylamine, octylamine, dodecylamine, hexadecylamine, octadecylamine, oleylamine, dimethylamine, diethylamine, dipropylamine, methylphosphine, ethylphosphine, propylphosphine, butylphosphine, pentylphosphine, diphenylphosphine, triphenylphosphine, and the like.

The third precursor may include a metal selected from a Group II metal other than Mg, a Group III metal, and a Group IV metal, or a non-metal selected from a Group V element and a Group VI element other than Se. In an embodiment, the metal or non-metal element included in the third precursor may be at least one selected from Zn, Ga, In, S, and Te. In a non-limiting example, the third precursor including a metal element may include a Group II metal except for Mg, a Group III metal, and a Group IV metal, and it may be a metal powder, an alkylated metal compound, a metal halide, a metal cyanide, or a combination thereof. Examples of the third precursor containing the metal element may include at least one selected from the group consisting of dimethyl zinc, diethyl zinc, zinc iodide, zinc bromide, zinc chloride, zinc fluoride, zinc cyanide, dimethyl cadmium, diethyl cadmium, cadmium iodide, cadmium bromide, cadmium chloride, cadmium fluoride, cadmium phosphide, to mercury iodide, mercury bromide, mercury chloride, mercury fluoride, mercury cyanide, lead bromide, lead chloride, lead fluoride, tin bromide, tin chloride, tin fluoride, germanium tetrachloride, trimethyl indium, indium chloride, and thallium chloride.

The third precursor containing a non-metal element may be at least one selected from the group consisting of hexanethiol, octanethiol, decanethiol, dodecanethiol, hexadecanethiol, mercaptopropylsilane, sulfur-trioctylphosphine (S-TOP), sulfur-tributylphosphine (S-TBP), sulfur-triphenylphosphine (S-TPP), sulfur-trioctylamine (S-TOA), trimethylsilyl sulfide, ammonium sulfide, sodium sulfide, tellurium-tributylphosphine (Te-TBP), tellurium-triphenylphosphine (Te-TPP), tris(trimethylsilyl)phosphine, tris(dimethylamino)phosphine, triethylphosphine, tributylphosphine, trioctylphosphine, triphenylphosphine, tricyclohexylphosphine, arsenic oxide, arsenic chloride, arsenic sulfate, arsenic bromide, arsenic iodide, nitric oxide, nitric acid, and ammonium nitrate.

The reaction may be conducted further in the presence of a first nanocrystal so that a nanocrystal shell of MgSe or an alloy thereof is formed on the surface of the first nanocrystal.

The first nanocrystal may be a Group III-V semiconductor nanocrystal core or a core-shell type semiconductor nanocrystal having a Group III-V semiconductor nanocrystal on the shell thereof. The first nanocrystal may be a Group II-VI semiconductor nanocrystal core or a core-shell type semiconductor nanocrystal having a Group II-VI semiconductor nanocrystal on the shell thereof.

The types and structure of the first nanocrystal may be chosen appropriately. In an embodiment, the first nanocrystal may be a semiconductor core or a core-shell type nanocrystal. The first nanocrystal may include at least one compound selected to from the group consisting of Group II-VI compounds, Group III-V compounds, and Group IV-VI compounds. The Group II-VI compounds may further include a Group III metal if desired. The Group II-VI compound may be selected from: a binary element compound selected from CdSe, CdTe, ZnS, ZnSe, ZnTe, ZnO, HgS, HgSe, HgTe, MgSe, MgS, and a combination thereof; a ternary element compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a combination thereof; and a quaternary element compound selected from HgZnTeS, CdZnSeS, CdZnSeTe, CdZnSTe, CdHgSeS, CdHgSeTe, CdHgSTe, HgZnSeS, HgZnSeTe, HgZnSTe, and a combination thereof. The Group III-V compound semiconductor may be selected from: a binary element compound selected from GaN, GaP, GaAs, GaSb, AIN, AIP, AIAs, AISb, InN, InP, InAs, InSb, and a combination thereof; a ternary element compound selected from GaNP, GaNAs, GaNSb, GaPAs, GaPSb, AINP, AINAs, AINSb, AIPAs, AIPSb, InNP, InNAs, InNSb, InPAs, InPSb, GaAINP, and a combination thereof; and a quaternary element compound selected from GaAINAs, GaAINSb, GaAIPAs, GaAIPSb, GaInNP, GaInNAs, GaInNSb, GaInPAs, GaInPSb, InAINP, InAINAs, InAINSb, InAIPAs, InAIPSb, and a combination thereof. The Group IV-VI compound may be selected from: a binary element compound selected from SnS, SnSe, SnTe, PbS, PbSe, PbTe, and a combination thereof; a ternary element compound selected from SnSeS, SnSeTe, SnSTe, PbSeS, PbSeTe, PbSTe, SnPbS, SnPbSe, SnPbTe, and a combination thereof; and a quaternary element compound selected from SnPbSSe, SnPbSeTe, SnPbSTe, and a combination thereof. The semiconductor nanocrystal may include at least two kinds of compounds. The binary element compound, ternary element compound, or quaternary element compound may be present in a to form of an alloy, or in a form of a structure wherein at least two different crystalline structures coexist as layers such as a core/shell or as compartments such as multi-pods. When the first nanocrystal has a core-shell structure, the nanocrystal having a core-multi-shell structure may be prepared.

In another embodiment, a nanoparticle includes a nanocrystal of a compound represented by Chemical Formula 1:

MgₐA_{b}Se [Chemical Formula 1]

wherein a is an atomic ratio of Mg with respect to Se, a+b=1, 0<a≦1, b is an atomic ratio of an element A, 0≦b<1, and the element A is a Group II metal other than magnesium, a Group III metal, a Group V non-metal element, a Group VI non-metal element other than selenium, or a combination thereof. For example, the element A may be at least one selected from Zn, Ga, In, S, and Te.

In an embodiment, the compound represented by Chemical Formula 1 may be MgSe.

The nanoparticle may have a multi-shell structure, and the nanocrystal of the compound represented by Chemical Formula 1 may be present as an interlayer between a Group III-V semiconductor nanocrystal (a core or shell) and a Group II-VI semiconductor nanocrystal (a core or shell). MgSe has a wide bandgap, may exhibit a carrier confinement effect, and may have a lower degree of lattice mismatch with other semiconductor materials such as InP. Therefore, the Mg—Se semiconductor nanocrystal of the aforementioned embodiment may serve as an excellent passivation material capable of preventing a charging phenomenon caused by the charge imbalance between the Group II-VI and the Group III-V semiconductor nanocrystals, and it may be useful as an interlayer material in a quantum dot of a multi-shell to structure. When the nanoparticle has a multi-shell structure, the nanocrystal of the compound represented by Chemical Formula 1 may be present as an interlayer between a Group III-V semiconductor nanocrystal and a Group II-VI semiconductor nanocrystal. Such a structure has an advantage that the nanocrystal interlayer of the compound represented by Chemical Formula 1 may play a role of balancing the charge difference between the Group III-V core and the Group II-VI shell.

The Group III-V semiconductor nanocrystal may include at least one selected from the group consisting of: a binary element compound selected from GaN, GaP, GaAs, GaSb, AIN, AIP, AIAs, AlSb, InN, InP, InAs, InSb, and a combination thereof; a ternary element compound selected from GaNP, GaNAs, GaNSb, GaPAs, GaPSb, AINP, AINAs, AINSb, AIPAs, AIPSb, InNP, InNAs, InNSb, InPAs, InPSb, GaAINP, and a combination thereof; and a quaternary element compound selected from GaAINAs, GaAINSb, GaAIPAs, GaAIPSb, GaInNP, GaInNAs, GaInNSb, GaInPAs, GaInPSb, InAINP, InAINAs, InAINSb, InAIPAs, InAIPSb, and a combination thereof. The Group III-V semiconductor nanocrystal may be a Group III-V semiconductor nanocrystal doped with a Group II element.

The Group II-VI compound may be selected from: a binary element compound selected from CdSe, CdTe, ZnS, ZnSe, ZnTe, ZnO, HgS, HgSe, HgTe, MgSe, MgS, and a combination thereof; a ternary element compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a combination thereof; and a quaternary element compound selected from HgZnTeS, CdZnSeS, CdZnSeTe, CdZnSTe, CdHgSeS, CdHgSeTe, CdHgSTe, HgZnSeS, HgZnSeTe, HgZnSTe, and a combination thereof.

The Mg—Se nanocrystal may have a particle diameter (the longest diameter in to case of a non-spherical particle) ranging from about 1 nm to about 100 nm, for example about 1 nm to about 20 nm. The shape of the semiconductor nanocrystal is not particularly limited. By way of an example, the nanocrystal may have a spherical shape, a pyramidal shape, a multi-arm shape, or a cubic shape. The nanocrystal may be in the form of a nanoparticle, a nanotube, a nanowire, a nanofiber, a nano-plate particle, or the like.

The Mg—Se nanocrystal may find their utility in various fields such as a light emitting diode (“LED”), a solar cell, and a biosensor.

Hereinafter, the present invention is illustrated in more detail with reference to specific examples. However, they are exemplary embodiments of the present invention, and the present invention is not limited thereto.

### Mode for Invention

### EXAMPLES

### Example 1

### Synthesis of MgSe Nanocrystal

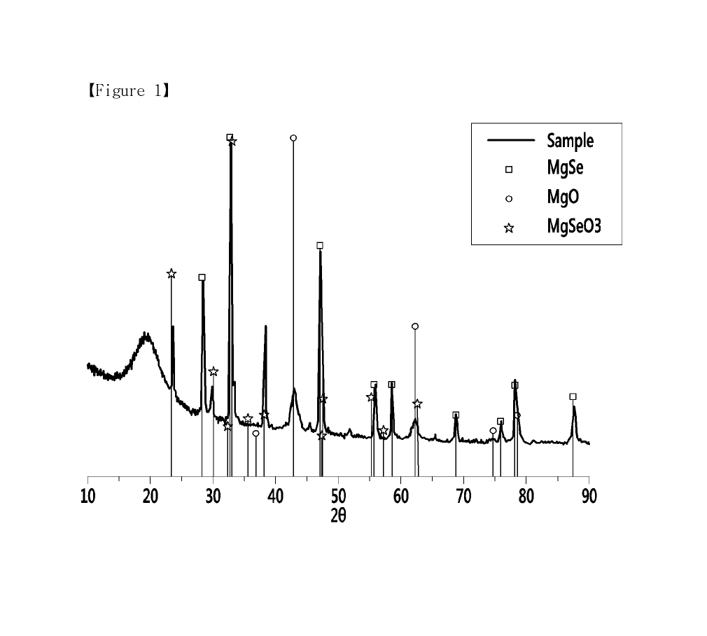

0.3 mmol of oleylamine and 10 mL of octadecene are placed in a reactor and then heated to 120° C. under vacuum so that oxygen sources are removed from the ligand and the solvent. 0.3 mmol of Mg(Bu)₂ and 0.75 mL of a 0.4 M Se/TOP (trioctylphosphine: TOP) solution are injected into the reactor, respectively, and heated to 280° C. to react for 12 hours. The reaction mixture thus obtained is cooled to room temperature and acetone is added thereto to obtain nanocrystals. The nanocrystals thus obtained are re-dispersed in a solvent such as chloroform, toluene, or hexane. An X-ray diffraction spectrum of the nanocrystal thus obtained is shown in FIG. 1. In FIG. 1, the peaks for MgO are due to the presence of MgO made by the oxidation of the sample during the XRD analysis. A UV spectrum of the nanocrystal thus obtained is shown in FIG. 4. The results of FIG. 1 and FIG. 4 confirm the to synthesis of MgSe nanocrystals.

### Example 2

### Synthesis of MgSe Nanocrystal II

MgSe nanocrystals are synthesized in the same manner as set forth in Example 1, except for using Se/diphenylphosphine (Se/DPP) as the Se precursor instead of Se/TOP. An X-ray diffraction spectrum of the nanocrystal thus obtained is shown in FIG. 2, and a UV spectrum of the nanocrystal thus obtained is shown in FIG. 4. The results of FIG. 2 and FIG. 4 confirm the synthesis of MgSe nanocrystals.

### Comparative Example

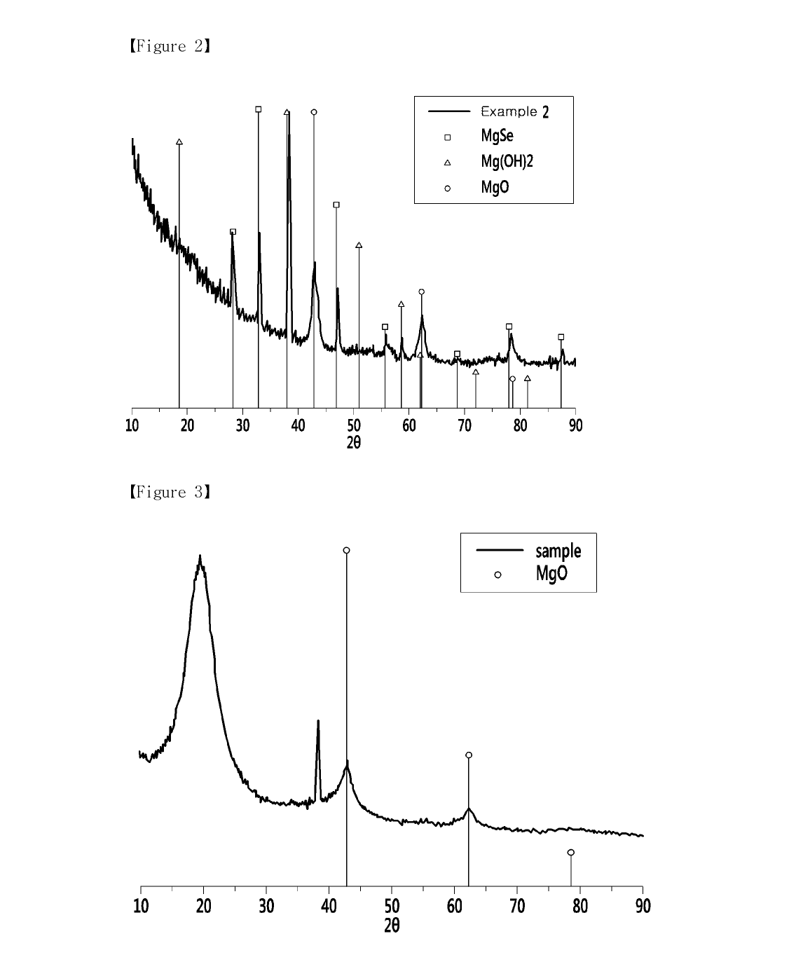

MgSe nanocrystals are synthesized in the same manner as set forth in Example 1, except for using 0.3 mmol of oleic acid instead of oleylamine. An X-ray diffraction spectrum of the nanocrystal thus obtained is shown in FIG. 3, and a UV spectrum of the nanocrystal thus obtained is shown in FIG. 4. The results of FIG. 2 and FIG. 4 confirm that MgSe nanocrystals are not synthesized.

### Example 3

### Synthesis of MgSe Nanocrystal III

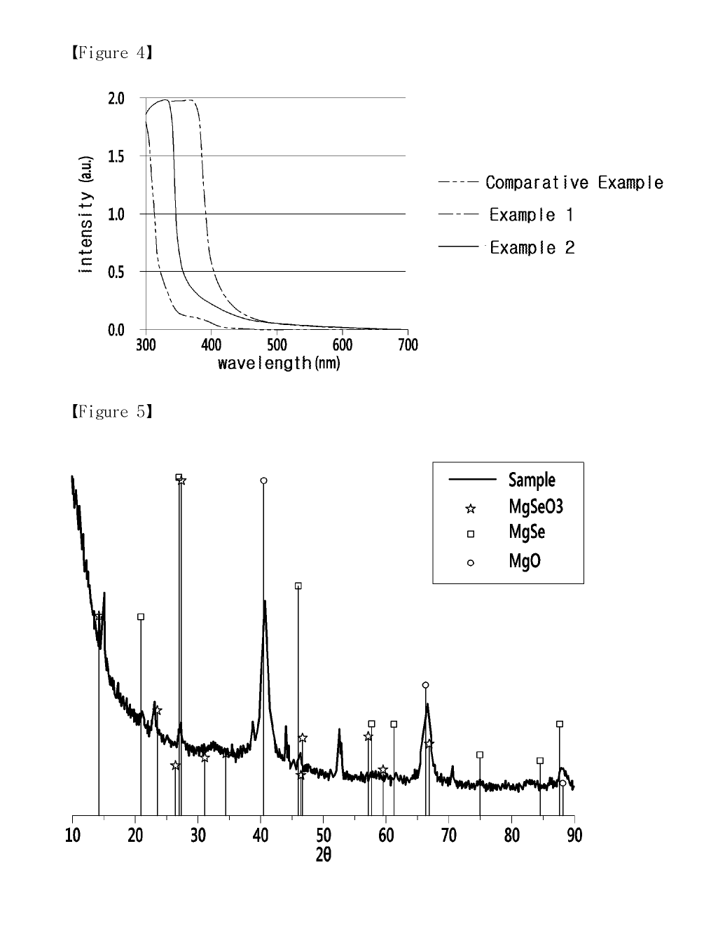

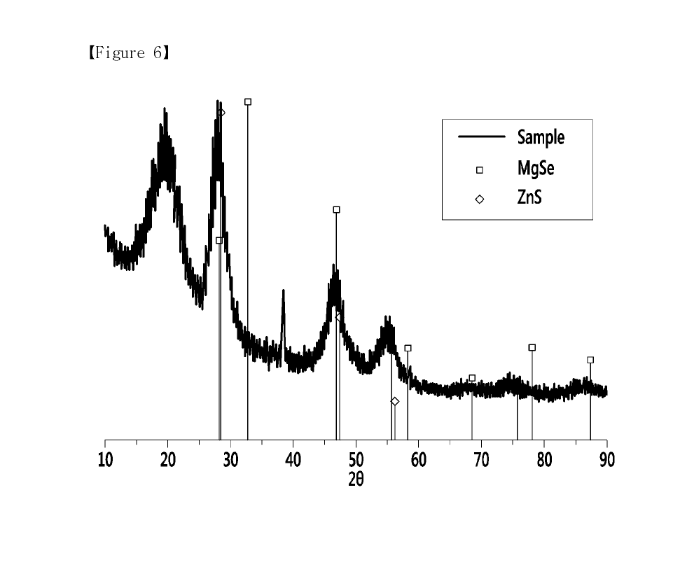

0.6 mmol of oleylamine and 10 mL of octadecene are placed in a reactor and then heated to 120° C. under vacuum so that oxygen sources are removed from the ligand and the solvent. 0.6 mmol of Mg(Bu)₂ and 1.5 mL of a 0.4 M Se/TOP (trioctylphosphine: TOP) solution are injected into the reactor, respectively, and heated to 280° C. to react for 12 hours. The reaction mixture thus obtained is cooled to room temperature and acetone is added thereto to obtain nanocrystals. An X-ray diffraction spectrum of the nanocrystal thus obtained is shown in FIG. 5. The results to of FIG. 5 confirm the synthesis of MgSe nanocrystals.

### Example 4

### Synthesis of MgSe/ZnS Nanocrystal

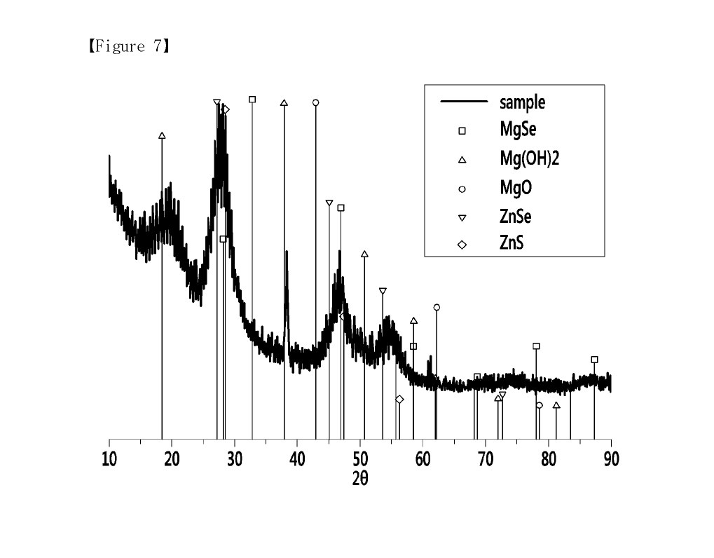

0.6 mmol of Zn(Oac)₂, 0.6 mmol of oleic acid, and 10 mL of trioctylamine (TOA) are placed in a reactor and then heated to 120° C. under vacuum so that oxygen sources are removed from the ligand and the solvent. In a glove box, the MgSe nanocrystals synthesized in Example 1 are separated, and 0.15 mmol of MgSe and 3 mL of a 0.4 M S/TOP solution are injected into the reactor, respectively, and heated to 280° C. to react for 12 hours. The reaction mixture thus obtained is cooled to room temperature and acetone is added thereto. The nanocrystals are obtained via centrifugation. An X-ray diffraction spectrum of the nanocrystal thus obtained is shown in FIG. 6. The results of FIG. 6 confirm the synthesis of MgSe/ZnS nanocrystals. The nanocrystals thus obtained are subjected to an inductively coupled plasma (ICP) analysis, and the results are summarized in Table 1. The nanocrystals exhibit the maximum light emitting peak wavelength at 365 nm and have a FWHM of 40 nm.

### Example 5

### Synthesis of Zn_{0.65} Mg_{0.35} Se/ZnS Nanocrystal

In a glove box, 0.6 mmol of oleylamine and 10 mL of octadecene are placed in a reactor and then heated to 120° C. under vacuum so that oxygen sources are removed from the ligand and the solvent. 0.21 mmol of Mg(Bu)₂, 0.39 mmol of Zn(Et)₂, and 1.5 mL of a 0.4 M Se/TOP (trioctylphosphine: TOP) solution are injected into the reactor, respectively, and heated to 280° C. to react for 12 hours. The reaction mixture thus obtained is cooled to room temperature and acetone is added thereto to precipitate ZnMgSe nanocrystals, which are then separated via to centrifugation. The nanocrystals thus obtained are re-dispersed in a solvent such as chloroform, toluene, or hexane.

0.6 mmol of Zn(Oac)₂, 0.6 mmol of oleic acid, and 10 mL of trioctylamine (TOA) are placed in a reactor and then heated to 120° C. under vacuum so that oxygen sources are removed from the ligand and the solvent. In a glove box, the ZnMgSe nanocrystals synthesized as above are separated, and 0.15 mmol of ZnMgSe and 3 mL of a 0.4 M STOP solution are injected into the reactor, respectively, and heated to 280° C. to react for 2 hours. The reaction mixture thus obtained is cooled to room temperature and acetone is added thereto. The nanocrystals are obtained via centrifugation. An X-ray diffraction spectrum of the nanocrystal thus obtained is shown in FIG. 7. The results of FIG. 7 confirm the synthesis of Zn_{0.65}Mg_{0.35}Se/ZnS nanocrystals. The nanocrystals thus obtained are subjected to an inductively coupled plasma (ICP) analysis, and the results are summarized in Table 1.

TABLE 1

Mole ratio %

| Sample | Mg | Se | Zn | S |
|---|---|---|---|---|
| MgSe/ZnS | 1 | 6.37 | 23.5 | 10.79 |
| ZnMgSe/ZnS | 1 | 46.75 | 136 | 66.25 |

### Example 6

### Synthesis of InP/MgSe/ZnS Nanocrystal

0.6 mmol of oleylamine and 10 mL of octadecene are placed in a reactor and then heated to 120° C. under vacuum so that oxygen sources are removed from the ligand and the solvent. 0.6 mmol of Mg(Bu)₂ and 1.5 mL of a 0.4 M Se/TOP (trioctylphosphine: TOP) solution are injected into the reactor, respectively, and heated to 280° C. to react for 5 hours. Then, InP nanocrystals prepared in advance and dispersed in toluene to form a dispersion having an optical density of 0.3 are injected into the reactor at a temperature of 280° C. and reacted at the same to temperature for 7 hours. The reaction mixture thus obtained is cooled to room temperature and acetone is added thereto to obtain InP/MgSe nanocrystals via centrifugation. The nanocrystals thus obtained are re-dispersed in a solvent such as chloroform, toluene, or hexane, and the InP/MgSe/ZnS nanocrystal is prepared in the same manner as set forth in Example 4.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A process for synthesizing Mg—Se nanocrystals, the process comprising
reacting a first precursor including magnesium and a second precursor including selenium in the presence of a ligand compound in an organic solvent to form to synthesize Mg—Se nanocrystals of comprising MgSe or an alloy thereof,
wherein the organic solvent and the ligand compound do not include an oxygen functional group.

2. The process of claim 1, wherein the first precursor is comprises an alkylated magnesium compound, a complex of magnesium metal and a phosphine compound, a complex of magnesium metal and a thiol compound, a magnesium halide, magnesium cyanide, a magnesium amide, a cycloalkenyl magnesium compound, a cycloalkyl magnesium compound, an allyl magnesium compound, bis(cyclopentadienyl)-magnesium, magnesium phthalocyanine, or a combination thereof.

3. The process of claim 1, wherein the second precursor is comprises a complex consisting of selenium and a dialkyl phosphine, a diaryl phosphine, a trialkyl phosphine, a triaryl phosphine, or a combination thereof, bis(trialkylsilyl)selenide, diphenyl selenide, an alkyl selenide, a cycloalkenyl selenide, a cycloalkyl selenide, or a combination thereof.

4. The process of claim 1, wherein the organic solvent is comprises a C6 to C22 primary alkyl amine, a C6 to C22 secondary alkyl amine, a C6 to C40 tertiary alkyl amine, a heterocyclic compound having a nitrogen atom, a C6 to C40 olefin, a C6 to C40 aliphatic hydrocarbon, an aromatic hydrocarbon substituted with a C6 to C30 alkyl group, a phosphine substituted with a C6 to C22 alkyl group, or a combination thereof.

5. The process of claim 1, wherein the ligand compound is comprises RNH₂, R₂NH, R₃N, RSH, R₃P, or a combination thereof, wherein R is independently a C1 to C24 alkyl group, a C2 to C24 alkenyl group, or a C5 to C20 aryl group.

6. The process of claim 1, wherein the reacting the first precursor and the second precursor comprises reacting the first and second precursors together with a third precursor that contains an element of a metal or a non-metal other than Mg and Se.

7. The process of claim 6, wherein the element of a metal or a non-metal is Zn, Ga, In, S, Te, or a combination thereof.

8. The process of claim 1, wherein the reacting the first precursor and the second precursor comprises reacting the first and second precursors in the presence of a first nanocrystal to form a nanocrystal shell of comprising MgSe or an alloy thereof on the surface of the first nanocrystal.

9. The process of claim 8, wherein the first nanocrystal is comprises a Group III-V semiconductor nanocrystal core, a Group II-VI semiconductor nanocrystal core, Group III-V semiconductor nanocrystal shell, a Group II-VI semiconductor nanocrystal shell, or a combination thereof.

10. A nanoparticle including a nanocrystal of a compound represented by Chemical Formula 1:
MgₐA_{b}Se [Chemical Formula 1]
wherein a is an atomic ratio of Mg with respect to Se, a+b=1, 0<a≦1, b is an atomic ratio of A, 0<b<1, and
wherein A is a Group II metal element other than magnesium, a Group III metal, a Group V non-metal element, a Group VI non-metal element other than selenium, or a combination thereof.

11. The nanoparticle of claim 10, wherein the compound represented by Chemical Formula 1 is MgSe.

12. The nanoparticle of claim 10, wherein the nanoparticle has a multi-shell structure, and
wherein the nanocrystal of the compound represented by Chemical Formula 1 is present as an interlayer between a Group III-V semiconductor nanocrystal and a Group II-VI semiconductor nanocrystal.

13. The nanoparticle of claim 12, wherein the Group III-V semiconductor nanocrystal comprises:
a binary element compound selected from GaN, GaP, GaAs, GaSb, AIN, AIP, AIAs, AISb, InN, InP, InAs, InSb, or a combination thereof,
a ternary element compound selected from GaNP, GaNAs, GaNSb, GaPAs, GaPSb, AINP, AINAs, AINSb, AIPAs, AIPSb, InNP, InNAs, InNSb, InPAs, InPSb, GaAINP, or a combination thereof, and
a quaternary element compound selected from GaAINAs, GaAINSb, GaAIPAs, GaAIPSb, GaInNP, GalnNAs, GalnNSb, GalnPAs, GalnPSb, InAINP, InAINAs, InAINSb, InAIPAs, InAIPSb, or a combination thereof, or
a combination thereof.

14. The nanoparticle of claim 13, wherein the Group III-V semiconductor nanocrystal is a Group III-V semiconductor nanocrystal doped with a Group II element.

15. The nanoparticle of claim 12, wherein the Group II-VI compound comprises:
a binary element compound selected from CdSe, CdTe, ZnS, ZnSe, ZnTe, ZnO, HgS, HgSe, HgTe, MgSe, MgS, or a combination thereof,
a ternary element compound selected from CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and or a combination thereof, and
a quaternary element compound selected from HgZnTeS, CdZnSeS, CdZnSeTe, CdZnSTe, CdHgSeS, CdHgSeTe, CdHgSTe, HgZnSeS, HgZnSeTe, HgZnSTe, and or a combination thereof, or
a combination thereof.

16. The nanoparticle of claim 10,
wherein the nanocrystal of the compound represented by Chemical Formula 1 comprises a ligand compound coordinated on a surface thereof, and
wherein the ligand compound comprises RNH₂, R₂NH, R₃N, RSH, and R₃P, or a combination thereof, wherein each R is independently a C1 to C24 alkyl group, a C2 to C24 alkenyl group, or a C5 to C20 aryl group.

17. The nanoparticle of claim 16, wherein the ligand compound is methylamine, ethylamine, propylamine, butylamine, pentylamine, hexylamine, octylamine, dodecylamine, hexadecylamine, oleylamine, octadecylamine, dimethylamine, diethylamine, dipropylamine; methylphosphine, ethylphosphine, propylphosphine, butylphosphine, pentylphosphine, diphenylphosphine, triphenylphosphine, or a combination thereof.
